(19) United States
(12) Patent Application Publication
(10) Pub. No.: US 2006/0086283 A1
(43) Pub. Date: Apr. 27, 2006

(54) Water repellent cellulose preservative

(75) Inventor: James N. Ray, Milton, FL (US)

Correspondence Address: Langdale & Vallotton, LLP, 1007 N. Patterson Street, P.O. Box 1547, Valdosta, GA, 31603, US

(73) Assignee: PREMIER WOOD TREATING, L.L.C.

(21) Appl. No.: 10/970,477

(22) Filed: Oct. 21, 2004

(51) Int. Cl. C09D 5/14; B05D 3/02

(52) U.S. Cl. 106/15.05; 427/393; 427/397

(57) ABSTRACT

The wood preservative is a compound that includes a water soluble wax that has a chemically basic pH that is about 9.5 to 13.5. The compound is blended with the wood being preserved. Subsequently, a silicate polymer with a basic pH that is chemically compatible with the wax pH and a viscosity of about 1 centipoise is further blended with the wood to form a matrix of wax and preservative that permeates the structure of the wood without chemically combining with the wood. The chips that form wood products of which oriented stand board is typical, are first dried to a moisture content of about 4% by weight and then blended with a resin to form with the wax a water repellant matrix for the wood preservative.

### BACKGROUND OF THE INVENTION

1. Field of the Invention

This invention relates to water repellent preservatives for cellulose materials and, more particularly, to a method for manufacturing oriented strand board by applying a wax, a resin, and a wood preservative to the constituent wood chips in that order and in which the wood preservative and the wax have chemically compatible pH values in a range encompassing 9.5 to 13.5, and the like.

2. Summary of the Prior Art

To produce a commercially acceptable wood composite material, of which oriented strand board (OSB) is typical, a number of criteria, apart from competitive manufacturing cost, must be satisfied. For example, the wood chips from which OSB is manufactured usually are tumble dried to an average moisture content of 4% by weight. A water based wood preservative is then applied to the dried flakes, the flakes thus absorbing the water and the preservative. The now treated flakes are once more tumble dried to drive out much of the water carrier and to leave a preservative residue in the redried wood flakes. Clearly, this second drying is a costly and burdensome manufacturing step. A failure, moreover, to purge an appropriate amount of the absorbed water from the wood chip fiber can produce steam when the wood chips are being pressed into board product. The consequence of this undesirable steam generation is the delamination of the processed board.

Mixing the preservative with a soap based wax and pressurizing this combination into the wood chips, particles or veneer by means of an hydraulic press also has been proposed. These waxes, however, are acidic, that is they enjoy a low pH. But these low pH value waxes not only are chemically incompatible with basic, or high pH preservatives, but low pH wood preservatives that are chemically compatible with low pH waxes also have the unfortunate feature of being environmentally detrimental. A further disadvantage of these wax processes is the highly flammable nature of the treated product.

Zinc borate also has been suggested as a preservative for composite wood products. This substance, however, has several undesirable characteristics, largely caused by the insolubility of the zinc borate in water. To a great extent this insolubility causes an uneven distribution of the preservative throughout the product. As a result, to cope with a situation in which areas of the product have an inadequate concentration of preservative, additional resin and zinc borate are added to the product that is being processed, thereby increasing both material and processing costs.

An alternative suggestion, applying a preservative directly to the wood being processed, coats the wood surfaces and inhibits resin and wax penetration into the wood. In this respect, adequate resin and wax penetration is important in the manufacture of a satisfactory product.

Prior art preservative treatments displayed further unsatisfactory characteristics. For instance, treated wood that was placed in contact with water through exposure in water courses, or to ground water, and the like was subject to leaching. Thus, the water to which the product was exposed extracted the preservative from the treated wood, thereby degrading the effectiveness of the preservative treatment. Impairing the strength of the preservative is, in many cases, not the worst consequence of leaching. For example, copper based preservatives leached from the wood and contaminating the natural water supply can cause severe environmental damage.

Accordingly, there is a need for a fire resistant wood preservative that overcomes these and other inadequacies of prior art wood treatment processes.

### BRIEF SUMMARY OF THE INVENTION

These deficiencies of the prior art are overcome, to a great extent, through the practice of the invention. Illustratively, in the production of OSB and other wood products, the wood being processed (e.g. wooden chips 3″ or 4″ in length and about 0.0025″ thick for OSB manufacture) are tumble dried to reduce the moisture content of the chips to about 4% by weight. The dried wood chips are then fed to two turning blenders, the contents of one of these blenders being destined to provide the product core and the contents of the other blender being prepared for the surfaces of the product.

This novel procedure, applying the constituents to the wood chips in the tumblers in the specific order of wax, resin, and then the preservative that locks the preservative in the coating of resin and wax on the surfaces of the wood chips. Thus, the treated wood chips, externally coated with resin, wax and preservative are pressed together in the further the manufacture of the OSB. By pressing the coated wood chips together, the wood preservative is locked by pressure and friction in a matrix of resin and wax that protects the wood chips without being absorbed in the wood fiber.

A particularly unusual feature of this process is the manner in which wood chips, processed in accordance with the invention, are protected by the matrix from further moisture absorption and thereby avoid product delamination that often accompanies an excess of residual process water trapped within the wood fiber.

Alternatively, manufacturing costs can be further reduced by combining the wax and preservative mixing steps into a single step in which the wax and the resin are applied to the wood chips in the tumblers at essentially the same time. By treating this part of the process as a single step, production time is reduced and the cost of manufacture, e.g. decreased tumbler processing time, also is reduced. In this instance, as in the foregoing illustration, the wax should have a high pH in order to be chemically compatible with the pH of the preservative.

Additionally, a biocide compound also can be applied to the wood chips through this process. Illustrative of the biocides that are suitable for this purpose are: silver nitrate; ethylene glycol; arsenic; halogens and particularly among the halogens, chlorine. For improved termite protection, moreover, 50% by weight of borax dissolved in 30% by weight of water also can be added to the wax.

When pressure treating other wood products, e.g. solid sawn lumber and veneer, it is preferable, in accordance with the invention to apply a chemically basic wax that has not only a high pH, but that also is stable in temperatures up to 180° F. and in vacuum and high pressure atmospheres. Finally, a chemically basic preservative, also characterized by a high pH that is compatible with pH of the wax treatment, is added to the blending mixture to complete the composition that is applied to the wood product.

Consequently, there is provided in accordance with feature of the invention an improved composite wood manufacturing process and product. Specific examples of the preferred embodiments of the invention are described in the following detailed description. The scope of the invention, however, is limited only through the claims appended hereto.

### DETAILED DESCRIPTION OF THE INVENTION

OSB characterizing salient features of the invention can be manufactured in the following manner:

a. Wood, either hardwood or softwood is chipped into 3″ to 4″ inch long flakes, with an average thickness of 0.0025″. For this purpose, a CAE Flaker, Model 37/118 Long Flaker, Serial No. 02W135 has been found satisfactory.

b. The wood chips are loaded into a tumble drier, of which a three pass tumble drier manufactured by Westec with a dual fuel burner is suitable for the purpose of the invention.

c. The wood chips are dried in the tumble drier until they have an average moisture content of about 4% by weight.

d. The dried wood chips are divided into two storage containers.

e. The contents of the two storage containers each are fed into a respective one of two turning blenders of which turning blenders with 1° angle of tilt, manufactured by Coil and identified as Serial No. 40-87-2 are suitable for use in connection with the invention.

f. First mixing a wax with the wood chips then is added to the mixture. A typical wax, suitable for use in the invention is described for instance in U.S. Patent Application Publication No. US2003/0131763 filed Feb. 4, 2003, for “Water Resistant Gypsum Formulation” and in which the wax is water soluble and, with a butyl acetate solvent, has a high pH in a range that encompasses 9.5 to 13.5 which also is chemically and physically compatible with environmentally acceptable wood preservatives. Further it has been found that the wax, marketed by the firm of Borden Chemical, Inc., of Columbus, Ohio, under the trademark “Bordenseal®”, also is acceptable for use in the invention.

g. Each of the tumble blenders then mix the wood chips with a resin that provides an adhesive for binding the wood chips together.

h. After mixing in the wax and the resin, a preservative, preferably a silicate based polymer formulation that includes a borate compound with a pH in the range of 11.5, a viscosity of 1 centipoise (cP) and in which the polymer has at least 30% by volume of silica, is added to each of the two blenders.

i. Optionally, a biocide can be added to the wood chips that are being processed; additional wax also can be added to create greater water repellency if the wax composition is compatible with the silicate polymer and remains stable after mixing.

It has been found that blending the wood chips with the resin, wax and silicate polymer is best accomplished in either a spin disk atomizer or an air atomizer blender because these blenders apply not only a complete, but also an even distribution of the blend to each individual wood chip in the composite board when used with the silicate polymer described above. Typical spin disk and air atomizers that provide acceptable results when used in the foregoing process are those in which the resin, wax and preservative are applied to spinning flakes through poly-urethane spinner cones in which, within the cones, are holes, each of one quarter inch diameter, evenly spaced with thirty holes in each spinner cone face. These cones are air fed, using a current of two amperes each, to spin at a speed of 850 to 1100 revolutions per minutes (rpm) in order to completely atomize the substances that are being applied to the wood chips being processed.

The silicate polymer, moreover, provides the environmentally acceptable wood preservative features, described herein below.

TABLE 1
Preservative Formulation

| | Percentage of Formula |
|---|---|
| Chemical Component | by Weight |
| Water | 61.45% |
| Sodium Silicate | 35.00% |
| Sodium Tetraborate Decahydrate | 3.00% |
| Parahydroxybenzoic Acid Methylester | 0.25% |
| Silicone Emulsion | 0.30% |

TABLE 2
Minimum and Maximum Percentages of Each Chemical
Component in the Preservative Formulation

| | Minimum Weight | Maximum Weight |
|---|---|---|
| Chemical Component | Percentage | Percentage |
| Water | 20.00% | 80.00% |
| Sodium Silicate | 1.00% | 80.00% |
| Sodium Tetraborate | 0.05% | 20.00% |
| Decahydrate | | |
| Parahydroxybenzoic Acid | 0.01% | 50.00% |
| Methylester | | |
| Silicone Emulsion | 0.01% | 50.00% |

TABLE 3
Preservative Formulation Plus Wax Additive

| | Percentage of Formula |
|---|---|
| Chemical Component | by Weight |
| Water | 61.45% |
| Sodium Silicate | 35.00% |
| Sodium Tetraborate Decahydrate | 3.00% |
| Parahydroxybenzoic Acid Methylester | 0.25% |
| Silicone Emulsion | 0.30% |
| Wax (30% Solid by Volume) | 20.00% |

TABLE 4
Minimum and Maximum Percentages of Each Chemical Component
in the Preservative Formulation Plus Wax Additive

| | Minimum Weight | Maximum Weight |
|---|---|---|
| Chemical Component | Percentage | Percentage |
| Water | 20.00% | 80.00% |
| Sodium Silicate | 1.00% | 80.00% |
| Sodium Tetraborate | 0.05% | 20.00% |
| Decahydrate | | |
| Parahydroxybenzoic Acid | 0.01% | 50.00% |
| Methylester | | |
| Silicone Emulsion | 0.01% | 50.00% |
| Wax | 0.01% | 50.00% |

By applying the wax, the resin and the preservative in the foregoing, specific order an unusual and important feature is added to the OSP product. Thus, a matrix of resin and wax is formed between the layers of dried wood flakes. The wood preservative, added in the last of the three steps, is locked in the resin and wax matrix. The resin, wax and the entrapped preservative coating on the dried wood flakes are then processed into OSB through an application of suitable pressure and friction. As a consequence of this processing, the preservative within the matrix protects the wood flakes from deterioration generally without actually being absorbed within the wood fibre. In this way, the silicate polymer affords further protection from moisture absorption because the preservative absorbs the moisture before it can invade the fibre of the wood chips.

In addition to improved composite board manufacture and fire resistance, the principles of the invention also are applicable to other cellulose products of which sawn lumber is illustrative.

The wax, as it is prepared for application to the wood chips in the turning blenders described in the foregoing process, also can be provided with a polymer for additional water repellency. This feature of the invention, however, requires the wax to be compatible with the polymer and to remain stable after mixing.

For example, the Borden product commercially available under the “Bordenseal®” trademark and a wood preservative are pressure treated into the wood that is being processed or otherwise coat the wood chips, particles or veneer. The Bordenseal® is water soluble and with a solvent butyl acetate has a high pH. Because of the high pH so provided, the “Bordenseal®” wax is chemically compatible with these cellulose preservatives that are environmentally acceptable. Further in this regard, when composite panels are heated during manufacture, it is believed that the wax bonds with the wood and the resins. This wax, moreover, is also thought to cross link with the silicate in the preservative to make the preservative water insoluble. A wood so made water repellent necessarily increases the effective life of the preservative in contrast with other preservative treatments.

An alternative treatment process within the scope of the invention is prepared in the following manner first to make a silicate polymer wood preservative by mixing:

| Constituent | Percentage by Weight |
|---|---|
| Sodium Silicate | 30% to 55% |
| Sodium Tetraborate Decaydrate | 1% to 15% |
| Silicon Emulsion (Dow Chemical) | 0.001% to 5% |
| Balance Water | |

Add a suitable biocide (e.g. parahydroxy benzoic acid methylester)

Add sodium hydroxide in order to increase the mixture pH to a range that encompasses 9.5 to 13.5. This produces a solution that is 21.7% solids and 100% saturated, chemically, and then to evaporate excess water to make 42% solids, to further reduce water in press.

Add a wax that exhibits a high pH, is chemically stable at temperatures up to 180° F. and is stable also in both vacuum and in high pressure environments. This low molecular weight wax is added to the foregoing mixture in amounts of 0.005% to 75% by volume. For improved termite protection, borax in the amount of 50% by weight also can be added to the wax with 30% more water.

This silicate polymer, moreover, also affords further improved protection from fire and moisture absorption by the wood chips because the preservative absorbs moisture before the moisture can invade the fibre of the wood chips.

In addition to improved composite board manufacture, the principles of the invention also are applicable to other cellulose products, of which sawn lumber is illustrative. The wax, as it is prepared for application to the wood chips in the turning blenders, also can be provided with a further polymer for additional water repellency. This feature of the invention, however, also requires the wax to be compatible with the polymer and to remain stable after mixing.

Thus, there is provided in accordance with the principles of the invention an improved wood product that has excellent water repellent and fire retardant properties. The preservative, moreover, in the matrix of resin and wax in the wood product, to the extent that the preservative becomes an effluent is environmentally more acceptable than prior art preservatives because it now is possible to combine, successfully, a basic, high pH wax with a chemically compatible (and environmentally less damaging) high pH preservative.

1. A wood preservative compound comprising a water soluble wax having a high pH and a silicate polymer with a borate having a basic pH that is chemically compatible with said wax pH in a range that encompasses 9.5 to 13.5 with a viscosity of about 1 centipoise and in which said silicate is at least 30% by volume of silica.

2. A compound according to claim 1 wherein the compound further comprises a biocide chosen from a group comprising silver nitrate, ethylene glycol, arsenic, alcohols and the halogens.

3. A preservative for pressure treated solid sawed lumber comprising a water soluble wax with a high, basic pH in the range that encompasses 9.5 to 13.5 and is stable in temperatures up to 180° F. and in both vacuum and high pressure atmospheres and a silicate based polymer with a borate having a high basic pH in a range that is chemically compatible with said wax pH with a viscosity of about 1 centipoise in which said silicate is at least 30% by volume of silica.

4. A preservative according to claim 3 wherein the preservative further comprises a biocide chosen from the group comprising silver nitrate, ethylene glycol, arsenic, alcohols and the halogens.

5. A method for processing a wood product comprising, in order, the steps of blending with the wood product a water soluble wax that has a high basic pH in the range that encompasses 9.5 to 13.5 and adding to the wood product and said wax a silicate based polymer that includes a borate compound with a pH that is chemically compatible with said wax pH and that has a viscosity of about 1 centipoise.

6. A method according to claim 5 further comprising the step of adding a resin to said wood product after said wax blending step.

7. A method according to claim 6 further comprising the step of drying the wood product to an average moisture content of 4% by weight before said resin adding step.

8. A method for pressure treating a wood product comprising, in order, the steps of blending a wax that has a basic pH in the range that encompasses 9.5 to 13.5 and stability in temperatures up to 180° F. and in vacuum and high pressure atmospheres and further blending with the wood product and said wax a silicate polymer that includes a borate compound with a pH that is chemically compatible with said wax pH and that has a viscosity of about 1 centipoise and in which said silicate is at least 30% by volume of silica.

9. A cellulose preservative comprising water, sodium silicate, sodium tetraborate decahydrate, parahydroxybenzoic acid methylester, and silicon emulsion.

10. A cellulose preservative according to claim 9 wherein the preservative further comprises water encompassing 20% to 80% by weight, sodium silicate encompassing 1% to 80% by weight, sodium tetraborate decahydrate encompassing 0.05% to 20% by weight, parahydroxybenzoic acid encompassing 0.01% to 50% by weight, and silicon emulsion encompassing 0.01% to 50% by weight.

11. A cellulose preservative comprising water encompassing 20% to 80% by weight, sodium silicate encompassing 1% to 80% by weight, sodium tetraborate decahydrate encompassing 0.05% to 20% by weight, parahydroxybenzoic acid methylester encompassing 0.01% to 50% by weight, silicon emulsion encompassing 0.01% to 50% by weight and wax encompassing 0.01% to 50% by weight.

12. A cellulose preservative comprising water in 61.45% by weight, sodium silicate in 35% by weight, sodium tetraborate decahydrate 3% by weight, parahydroxybenzoic acid methylester 0.25% by weight, silicon emulsion 0.30% by weight, and balance wax.

13. A cellulose preservative comprising sodium silicate encompassing 30% to 55% by weight, sodium tetraborate decahydrate encompassing 1% to 15% by weight, silicon emulsion encompassing 0.001% to 5% by weight, balance water and biocide.

14. A cellulose preservative according to claim 13 further comprising a low molecular weight wax encompassing 0.005% to 75% by volume.

15. A cellulose preservative according to claim 13 further comprising borax in the amount of about 50% by weight.

16. A cellulose preservative according to claim 15 further comprising water in the amount of about 30%.
